(19) United States
(12) Patent Application Publication
(10) Pub. No.: US 2006/0047786 A1
(43) Pub. Date: Mar. 2, 2006

(54) Network retrieval system, information retrieval method, bridge device and program

(75) Inventor: Yusuke Doi, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/129,433

(22) Filed: May 16, 2005

(30) Foreign Application Priority Data
May 19, 2004 (JP) 2004-149416

(51) Int. Cl. G06F 15/177

(52) U.S. Cl. 709/220

(57) ABSTRACT

There is provided network retrieval system, information retrieval method, bridge device and program in which in case where any one of plural computers arranged on a network is instructed to retrieve certain information, the plural computers cooperate to retrieve the certain information by using a distributed hash table according to a distributed hash algorithm. A client device requests a bridge device to resolve a domain name; the bridge device selects one of converting devices arranged correspondingly to the computers; the bridge device notifies the client device of a location of the selected converting device; the client device requests the selected converting device to resolve the domain name; the converting device instructs the corresponding computer to carry out retrieval based on a name resolving request to receive a retrieved result; and the converting device transmits the retrieved result as a response to the name resolving request to the client device.

### CROSS-REFERENCE TO RELATED APPLICATIONS

This application is based upon and claims the benefit of priority from the prior Japanese Patent Applications No. 2004-149416, filed on May 19, 2004; the entire contents of which are incorporated herein by reference.

### BACKGROUND OF THE INVENTION

1. Field of the Invention

The present invention relates to a network retrieval system, an information retrieval method, a bridge device and a program.

2. Related Art

Domain name system (DNS) that manages domain name space having a tree structure is widely used in the Internet or the like. In the DNS, DNS servers that manage zones are theoretically connected in a tree form. Users inquire of the DNS about a domain name, and can acquire information related with the domain name.

More concretely, in order to acquire information related with domain name, in general, the user device inquires of the DNS about the domain name recursively, and specify DNS server that manages zone of the domain name to acquire the information related with the domain name from the specified DNS server.

In such a DNS, however, for example, in the case where many pieces of information are stored in a DNS server that manages a certain zone (a lot of records are stored), it takes a long time to retrieve information in the DNS server. Further, in the case where a lot of DNS inquiries from all over the world are concentrated on the DNS server, a delay of the process becomes more serious.

### SUMMARY OF THE INVENTION

According to an aspect of the present invention, there is provided a network retrieval system including plural computers arranged on a network in which in case where any one of the computers is instructed to retrieve certain information, the plural computers cooperate to retrieve the certain information by using a distributed hash table according to a distributed hash algorithm, comprising: plural converting devices arranged correspondingly to the plural computers, wherein each converting device has authority to manage a first domain as a part of a domain name space, and in case of receiving a name resolving request for a domain name including the first domain, instructs the corresponding computer to carry out retrieval based on the name resolving request and receives a result retrieved according to the distributed hash algorithm from the corresponding computer to transmit the retrieved result as a response to the name resolving request; a bridge device that manages the converting devices and has authority to manage a second domain whose hierarchy is higher than that of the first domain, and in case of receiving a name resolving request for the domain name including the first domain, notifies a transmission source of the name resolving request of at least any location of the converting devices to which the name resolving request is entrusted; and a client device that requests the bridge device to resolve the domain name including the first domain to acquire the location of the converting device to which a name resolving request is entrusted, and requests the converting device having the acquired location to resolve the domain name including the first domain to acquire a retrieved result from the converting device.

According to an aspect of the present invention, there is provided An information retrieval method in which in case where any one of plural computers arranged on a network is instructed to retrieve certain information, the plural computers cooperate to retrieve the certain information by using a distributed hash table according to a distributed hash algorithm, comprising: requesting by a client device a bridge device to resolve a domain name including a first domain as a part of domain name space, the bridge device having authority to manage a second domain whose hierarchy is higher than that of the first domain; selecting by the bridge device at least any one of converting devices arranged correspondingly to the computers, the converting devices having authority to manage the first domain, respectively; notifying by the bridge device the client device of a location of the selected converting device to which a name resolving request is entrusted; requesting by the client device the converting device having the notified location to resolve the domain name including the first domain; instructing by the converting device the corresponding computer to carry out retrieval based on a name resolving request from the client device, to receive a result retrieved according to the distributed hash algorithm from the corresponding computer; and transmitting by the converting device the retrieved result as a response to the name resolving request to the client device.

According to an aspect of the present invention, there is provided a bridge device that has authority to manage certain domain in a domain name space, comprising: a management unit that manages plural computers arranged on a network, wherein in case where one of the computers is instructed to retrieve certain information, the plural computers cooperate to retrieve the certain information by using a distributed hash table according to a distributed hash algorithm; a selecting unit that selects at least any one of the plural computers in case of receiving a name resolving request for a domain name including the certain domain; and a responding unit that transmits a location of the selected computer as a response to the name resolving request.

According to an aspect of the present invention, there is provided a program for inducing a device that has authority to manage certain domain in a domain name space, to execute: receiving a name resolving request for a domain name including the certain domain; selecting at least any one of plural computers arranged on a network, wherein in case where any one of the computers is instructed to retrieve certain information, the plural computers cooperate to retrieve the certain information by using a distributed hash table according to a distributed hash algorithm; and transmitting a location of the selected computer as a response to the name resolving request.

### BRIEF DESCRIPTION OF THE DRAWINGS

FIG. 1 is a diagram illustrating a network retrieval system according to an embodiment of the present invention.

FIG. 2 is a diagram illustrating the network retrieval system according to another embodiment of the present invention.

FIG. 3 is a diagram illustrating a bridge device.

FIG. 4 is a diagram illustrating a first application example of the network retrieval system in FIG. 2.

FIG. 5 is a diagram illustrating a second application example of the network retrieval system in FIG. 2.

FIG. 6 is a diagram explaining an operation of a node group management unit.

### DETAILED DESCRIPTION OF THE INVENTION

The present embodiment is characterized in that a distributed hash table (DHT) network executing retrieval according to distributed hash algorithm typified by the Chord algorithm is connected to a domain name system (DNS) which is used in the existing the Internet and the like, and thus the DHT network can be used from a user's device via the existing DNS.

Reference documents relating to DHT include a document about Chord that is the representative example of the distributed hash algorithm (Ion Stoica, Robert Morris, David Karger, M. Frans Kaashoek, and Hari Balakrishnan, Chord: A Scalable Peer-to-peer Lookup Service for Internet Applications, ACM SIGCOMM 2001). The reference documents relating to DHT further include RFC1034 and RFC1035.

The characteristics of the DHT network will be explained below.

In the DHT network, computers composing the DHT network can accept a retrieval instruction, respectively. When a certain computer receives a retrieval instruction, the computers cooperate to execute the retrieval. That is to say, in the DHT network, communication and authorities are not concentrated on a specified computer. Since load is distributed to the respective computers, a lot of retrieval requests can be processed at high speed. Further, since the DHT network has high fault tolerance, computers can be introduced in a gradual manner. That is to say, when overall load increases, the computer may be added every time of the increase. In other words, when the DHT network is designed, it is less necessary to specify a place (computer) on which the load is concentrated and heighten the tolerance of that place in advance.

In the DHT network, when a number of the computers composing the DHT network increases, a capacity of the DHT network (processing speed, storage capacity and the like) increases in proportion to the increase in the number of the computers. On the contrary, communication and a remote invocation procedure (one of the methods that a certain computer requests another computer to execute the process via the network) in the DHT network increase at a slower pace. The performance of the DHT network, therefore, can be extended easily by adding the computers.

In this embodiment, the DHT network having the above characteristics is used via the existing DNS, so that a lot of retrieval is capable of be processing at high speed, thereby realizing the network retrieval system having high durability and high extensibility.

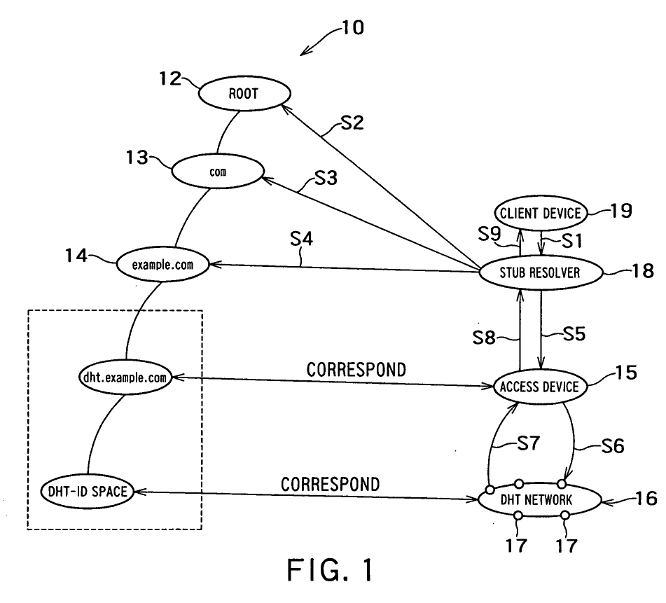

FIG. 1 is a diagram schematically illustrating the network retrieval system according to the embodiment of the present invention.

DNS 10 in FIG. 1 manages a domain space having a tree structure and has a DNS server group that is theoretically connected in a tree form. FIG. 1 illustrates DNS servers 12 to 14 as a part of the DNS server group. The DNS server 12 is entrusted management of root domain to, the DNS server 13 is entrusted management of “com” domain to, and the DNS server 14 is entrusted management of “example.com” domain to.

A stub resolver 18 receives a DNS inquiry about a domain name from a client device 19, and executes DNS inquires for the DNS 10 and an access device 15 mentioned later, to acquire information related with the domain name from the DHT network 16 via the access device 15 and return the acquired information to the client device 19. The DNS inquiry corresponds to, for example, a name resolving request.

The DHT network 16 has a plurality of computers 17 that execute retrieval according to the distributed hash algorithm. The space of the DHT network 16 is an ID space composed of n bits. The ID space of the DHT network 16 is different from a domain name space of DNS having the tree structure and does not have a specified hierarchical structure. IDs of n bit are allocated to the computers 17 in the DHT network 16, respectively. The computers 17 manage databases (distributed hash tables). In the database, the IDs of n bit are related with respective information peaces. The computers 17 manage IDs in predetermined ranges, respectively. When an arbitrary computer 17 in the DHT network 16 receives the retrieval request including certain retrieval information, it inputs the received retrieval information into a predetermined hash function (for example, SHA1) to acquire a hash value (ID) (when SHA1 is used, a unique value of 160 bits). Thereafter, computer 17 that manages the acquired ID in the database is specified by the cooperation of the plural computers 17. The specified computer 17 retrieves information related with the acquired ID from its own database, and the computer that made the retrieval or the computer that receives the retrieval request returns the retrieved information as a retrieved result.

The access device 15 realizes an access to the DHT network 16 from the stub resolver 18 via the DNS 10. That is to say, it is possible to access to the ID space of the DHT network 16 from the domain name space of the DNS 10 that is common worldwide. For this purpose, it is necessary to allocate a part of the domain name space of the DNS 10 for the ID space of the DHT network 16. Concretely, the entire ID space of the DHT network 16 which do not have the hierarchical structure is corresponded to certain hierarchy of the domain name space in the DNS 10, namely, certain single domain.

More concretely, as shown in FIG. 1, the authority to a part of the domain name space in the DNS 10 (in this example, “dht.example.com”) is delegated to the access device 15 (the domain name of the access device 15 is “ns.dht.example.com”). In order to delegate the authority, the delegation of the authority is described in an upper DNS server such as the DNS server 14 (manages the domain “example.com”) by using an NS resource record. Concretely, in order to entrust the DNS inquiry for lower hierarchy domain than “dht.example.com” (domain including “dht.example.com” as a part) to the access device 15, the following combination of the resource records are recorded in the DNS server 14. When plural access devices are arranged, the combinations of the resource records for the respective access devices are recorded.
dht.example.com. IN NS ns.dht.example.com
ns.dht.example.com IN A (IPv4 address allocated to the access device 15)
ns.dht.example.com IN AAAA (IPv6 address allocated to the access device 15)

With this recording, the authority to the domain “dht.example.com” is delegated to the access device 15. All the DNS inquiries for the domain names including the domain “dht.example.com” are, therefore, entrusted to the access device 15. That is to say, the access device 15 interprets the DNS inquiries for the lower hierarchy domains than the domain “dht.example.com”.

When the access device 15 receives the DNS inquiry for domain name including its own domain from the stub resolver 18, it generates information for requesting retrieval to the DHT network 16 based on the received DNS inquiry. The access device 15 transmits a retrieval request including the generated retrieval information to any one of the computers 17 in the DHT network 16. The computer 17 may be selected by using a predetermined method, mentioned later. The access device 15 receives the retrieved result from the DHT network 16, and returns the received retrieved result as a response to the DNS inquiry from the stub resolver 18 by using a message format according to a DNS protocol. The stub resolver 18 returns the retrieved result as the response to the DNS inquiry from the client device 19.

An example of the operation by the network retrieval system will be explained below.

The client device 19 requests the stub resolver 18 to execute DNS inquiry for a domain name (for example, “1234.dht.example.com”) input by a user or the like such as (S1).

The stub resolver 18 recursively inquires of the DNS servers 12 to 14 successively, and acquires information about the delegation of the authority to the access device 15 for the domain “dht.example.com” from the DNS server 14 (S2 to S4). Accordingly, the stub resolver 18 DNS-inquires of the access device 15 (S5).

The access device 15 generates information for requesting retrieval for the DHT network 16 based on the DNS inquiry from the stub resolver 18. For example, the access device 15 extracts “1234” from the domain name “1234.dht.example.com” related with the DNS inquiry, as the retrieval information. That is to say, in this case, the access device 15 extracts the domain “1234” which is of lower level than the domain “dht” managed by itself as the retrieval information (S6). The access device 15 transmits the extracted retrieval information to any one of the computers 17 in the DHT network 16 (S6).

The computer 17 acquires a hash value (ID) of the received retrieval information (1234), and a computer 17 that manages the ID is specified by the cooperation of the computers 17 (S7). The specified computer 17 retrieves information related with the ID (for example, URL, and IP address) from its own database, and this computer 17 or the computer 17 which receives the retrieval information returns the retrieved result to the access device 15 (S7).

The access device 15 returns the received retrieved result as a response to the DNS inquiry from the stub resolver 18 to the stub resolver 18 (S8).

The stub resolver 18 returns the received retrieved result as the response to the DNS inquiry from the client device 19 to the client device 19 (S9). Thereafter, when the retrieved result is URL, for example, the client device 19 accesses to a device to which the URL is allocated (not shown) to acquire desired information (for example, information about a product having a serial number 1234).

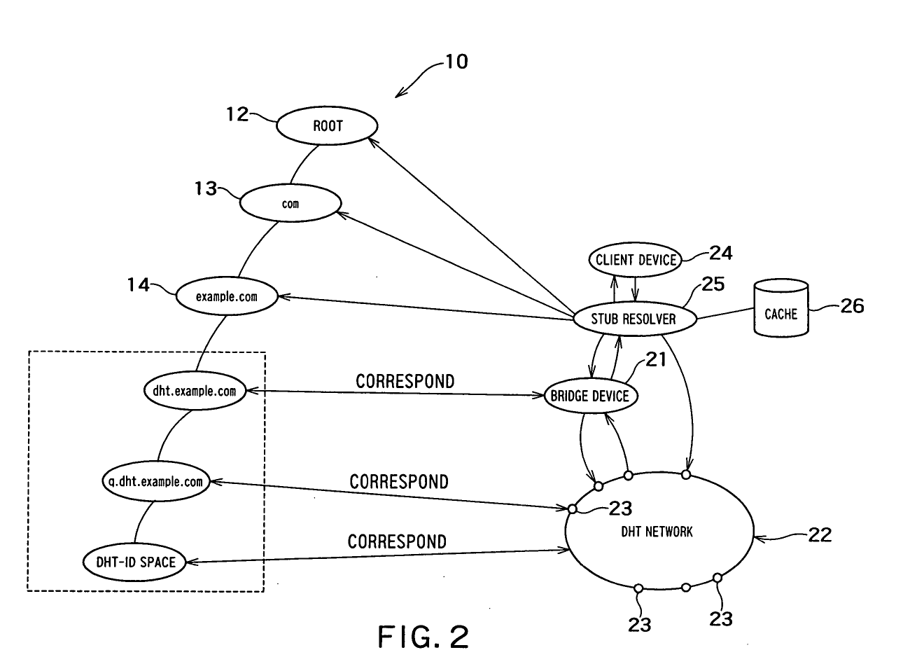

FIG. 2 is a diagram illustrating the network retrieval system according to another embodiment of the present invention.

In the above-mentioned embodiment, since the access device 15 should receive the retrieval request to the DHT network 16 and the retrieved result from the DHT network 16, when a lot of DNS inquiries are concentrated to the access device 15, the access device 15 becomes a bottleneck, and thus the overall process is delayed. This embodiment solves such a problem. The embodiment will be explained in detail below.

As shown in FIG. 2, a bridge device 21 is entrusted management of a specified domain (first domain) (in this example, “dht.example.com”) in the domain name space of DNS 10 to. A resource record for delegating the authority for the domain “dht.example.com” to the bridge device 21 is recorded in a DNS server such as the DNS server 14 that manages a domain (example.com) that is of higher-level than the domain “dht.example.com”. When a plurality of bridge devices 21 are arranged, the authority is delegated to each bridge device. The bridge device 21 will be further detailed below.

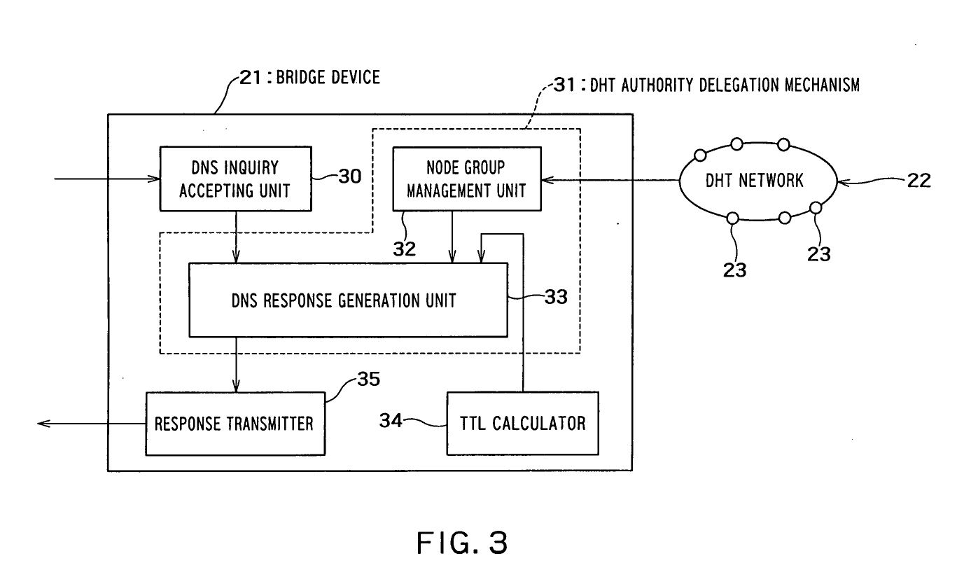

FIG. 3 is a block diagram illustrating the bridge device 21. The function performed by this device 21 may be also realized by causing a computer to execute a program.

As shown in FIG. 3, a DNS inquiry accepting unit 30 in the bridge device 21 accepts a DNS inquiry from the stub resolver 25 forwarded from the DNS server 14 (for example, the DNS inquiry for “123456.q.dht.example.com”).

When the DNS inquiry accepting unit 30 accepts the DNS inquiry, a TTL calculator 34 calculates TTL (Time to Live) by using a preset constant or a method mentioned later, and outputs TTL to a DNS response generating unit 33.

When the DNS inquiry accepting unit 30 accepts the DNS inquiry, a DHT authority delegation mechanism 31 in the bridge device 21 delegates authority for a domain (second domain) (in this example, “q.dht.example.com”) (see FIG. 2) which is lower level than the first domain (“dht.example.com”) to the computer 23 which is selected by a predetermined method (mentioned later). The DHT authority delegation mechanism 31 will be further detailed below.

A node group management unit 32 in the DHT authority delegation mechanism 31 accesses to the DHT network 22 as needed, and collects information about computers 23 in the DHT network 22 (IP address and the like) to produce a list of the computers (for example, the list of the IP addresses). The node group management unit 32 corresponds, for example, a management unit and a selecting unit.

When the DNS inquiry accepting unit 30 accepts the DNS inquiry, the node group management unit 32 selects a computer 23 by using a predetermined method based on the produced list of the computers. More concretely, a suitable number of the computers are selected by a suitable method.

Here, “The suitable number” is, for example, the number of the computer addresses that can be included in an UDP datagram to be used for the response to the DNS inquiry. If a pair of an IPv4 address and an IPv6 address is included in a datagram of 512 bytes, the number of the pairs is predicted to be 5 to 10.

“The suitable method” includes a random selecting method, a method of selecting computers according to a loading state of the computers, a method of selecting computers having a network routing path near an IP address of an inquiry source (stub resolver 25), and a combination of some of these method. These will be further detailed later.

The node group management unit 32 outputs information about one or plural computer(s) selected by the specified method (for example, IP address) to the DNS response generating unit 33.

The constitution of group of the computers 23 in the DHT network 22 always changes and is indefinite. Accordingly, when the node group management unit 32 detects that a computer disengages from the DHT network 22, it deletes the information about that computer.

When the DNS inquiry accepting unit 30 accepts the DNS inquiry, the DNS response generating unit 33 in the DHT authority delegation mechanism 31 generates a resource record that represents the delegation of the authority for the second domain (q.dht.example.com) to the compute 23 selected by the node group management unit 32. Concretely, the DNS response generating unit 33 generates domain name for the selected computer 23, and generates an NS resource record and glue A/AAAA record (DNS record). The following shows the DNS record generated for the computer having IPv4 address 1.2.3.4 as one example. The description of the DNS record is based on BIND.
q.dht.example.com. 6435 IN NS 1-2-3-4.n.q.dht.example.com 1-2-3-4.n.q.example.com. 6435 IN A 1.2.3.4

“6435” is TTL calculated by the TTL calculator 34. “1.2.3.4.n.q.dht.example.com” is a domain name generated based on the IPv4 address. “1.2.3.4” is the IPv4 address of the selected computer.

A response transmitter 35 transmits a message including the DNS record(s) generated by the DNS response generating unit 33 to the DNS inquiry source (stub resolver 25). The stub resolver 25 recognizes the delegation of the authority based on the DNS record in the message. The stub resolver 25 DNS-inquires of a computer having an IP address in the message (when the message includes a plurality of IP addresses, one IP address selected from them) (for example, the DNS inquiry about “123456.q.dht.example.com”).

Here, as is clear from the above explanation, when the bridge device 21 receives the DNS inquiry from the stub solver 25, it delegates the authority for the second domain (q.dht.example.com) to the computer(s) 23 selected by the specified method. The delegating destination of the authority can be, therefore, suitably distributed, and thus the DNS inquiries from the stub resolver 25 are not concentrated on a specified computer.

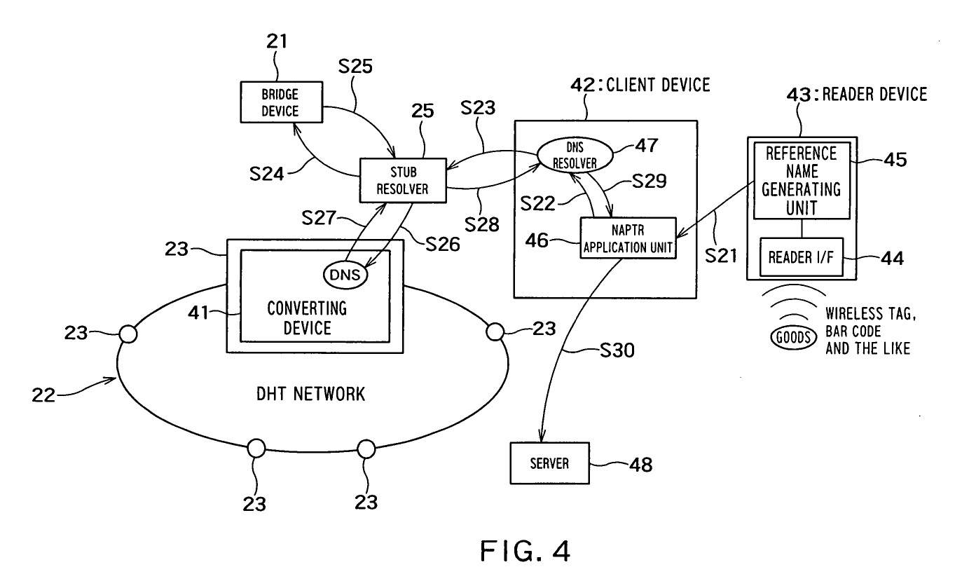

With reference to FIG. 2, each of computers 23 of the DHT network 22 has a converting device (see reference numeral 41 in FIG. 4) that converts the DNS inquiry from the stub resolver 25 into a DHT inquiry. This converting device has an approximately similar function to that of the access device 15 in FIG. 1. More concretely, when the converting device receives the DNS inquiry from the stub resolver 25, it produces (extracts) retrieval information based on (from) the DNS inquiry, and the computers 23 cooperate to carry out retrieval by using the retrieval information. The converting device in the computer that has the retrieved information or the converting device that receives the DNS inquiry returns the retrieved result as the response to the DNS inquiry to the inquiry source (stub resolver 25).

For example, when the converting device in the certain computer 23 receives the DNS inquiry for “123456.q.dht.eample.com” from the stub resolver 25, the converting device in this computer 23 extracts 123456 as the retrieval information from “123456.q.dht.example.com”, and this computer 23 obtains a hash value (ID) from the retrieval information. The DHT network 22 specifies a computer that manages the hash value, and the specified computer retrieves information (for example, URL, IP address) related with the hash value from its own database. The converting device in this computer or the converting device in the computer that receives the DNS inquiry returns the retrieved result as the response to the DNS inquiry to the inquiry source (stub resolver 25).

Here, as shown in FIG. 2, the stub resolver 25 has a cache mechanism 26 that stores the retrieved result for a period represented by TTL. The bridge device 21, therefore, controls the TTL value to be capable of controlling the load of the converting devices and the bridge device 21. For example, when the bridge device 21 sets TTL to a long time, stub resolver 25 directly uses one converting device for a long time without access to the bridge device 21. That is to say, since the stub resolvers worldwide directly use different converting devices for a long time respectively without access to the bridge device 21, the load of the bridge device 21 is reduced. The detailed method of controlling TTL will be explained later.

An application example of the network retrieval system in FIG. 2 will be explained below.

In the following application example, there assumes the case where code for accessing to a device where information about goods is stored (for example, URL (Uniform Resource Locator), NAPTR (Naming Authority Pointer), and the like) is acquired from the DHT network based on retrieval code (goods number) such as EPC code (Electronic Product Code) allocated to the goods.

At first, a method of recording codes in the DHT network will be simply explained.

A producer and a circulator of goods use the DHT network as a common base for managing the goods information. For example, the producer records codes for accessing to devices where the information about the goods is stored, into the DHT network. The circulator records codes for accessing to the device that stores information about circulation of the goods therein, into the DHT network. More concretely, the codes are recorded in a manner to be explained in the following example.

That is to say, code, time stamp, hash value of public key, and signature (first signature) for the set of the code, the time stamp and the hash value by a secret key are recorded in each computer of the DHT network, by using the hash value (ID) of the goods number as a key. The computer into which they are recorded is automatically determined according to, for example, the hash value (ID). That is to say, the respective computers manage IDs in predetermined ranges, and ID is recorded in a computer that manages this ID. Various recording methods such as a method that uses the hash value of a combination of a goods number and a code type (for example “URL”, “NAPTR”) as the key instead of the hash value of the goods number can be used.

Also a public key and a signature (second signature) for the public key by a secret key are recorded in the computer by using the hash value of the public key as the key. As a result, when, for example, the hash value of the goods number is retrieved as a retrieval key, a hash value of the public key included in the retrieved data is again retrieved as a retrieval key, and the first signature acquired by the first retrieval is decoded by the public key included in the data acquired by the second retrieval. In such a manner, validity of the data acquired by the first retrieval can be verified.

The case where a general user acquires a code from the DHT network based on a goods number or the like and accesses to a device which stores goods information therein based on the acquired code will be concretely explained below as an application example (first and second application examples) of the network retrieval system in FIG. 2.

FIG. 4 is a diagram illustrating the first application example of the network retrieval system in FIG. 2.

In this example, a reader device generates a domain name using a goods number read from the goods, and a client device makes the DNS inquiry for the domain name. The client device acquires an NAPTR record (for example, URI, SIP address, e-mail address) as the response to the DNS inquiry, and accesses to a server that provides the service using the NAPTR record by using the acquired NAPTR record. Such a mechanism is general in the service or the like using ENUM, but this example is characterized in that the DHT network is used via DNS transparently to acquire the NAPTR record. This example will be explained in detail below.

A reader I/F 44 in the reader device 43 reads a goods number from goods. The reader I/F 44 is, for example, a bar-cord reader, a wireless tag reader or the like.

A reference name generating unit 45 in the reader device 43 generates a domain name (reference name) by using the read goods number. For example, the following reference name is generated for the goods number 123456:
123456.q.dht.example.com

A reference name generating unit 45 transmits the generated reference name to an NAPTR application unit 46 in the client device 42 by using arbitrary communication means such as Bluetooth or serial cable (S21).

The NAPTR application unit 46 transmits the received reference name to a DNS resolver 47 (S22). The DNS resolver 47 DNS-inquires of the stub resolver 25 about the reference name (S23).

The stub resolver 25 receives the DNS inquiry from the DNS resolver 47 and DNS-inquires of the DNS 10 (see FIG. 10) about the reference name in repeating fashion (recursive inquires). As a result, for example, the stub resolver 25 acquires an IP address or the like of the bridge device 21 to which the authority for the domain “dht.example.com” is delegated from the DNS server 14 that manages the domain “example.com”. The stub resolver 25 DNS-inquires of the bridge device 21 as the authorized device (S24).

When the bridge device 21 receives the DNS inquiry from the stub resolver 25, it selects computers whose number (suitable number) is determined by redundancy parameter according to a suitable method, and generates DNS records for delegating the authority for the domain “q.dht.example.com” to the selected computers.

That is to say, the bridge device 21 firstly generates domain names for the selected computers. For example, in the case where the selected computer, more specifically, the converting device in the selected computer have an IP address “1.2.3.4”, the bridge deice 21 generates a domain name “1-2-3-4.n.q.dht.example.com” based on the IP address. In the case where the IP address is IPv6 address, a portion corresponding to “1-2-3-4” may be compressed by a suitable digest function.

The bridge device 21 calculates TTL by using a preset constant or a method mentioned later.

The bridge device 21 generates, for example, the following NS resource record and glue A/AAAA record (DNS record) for the selected computer by using the generated domain name and the calculated TTL.
q.dht.example.com.6435 IN NS 1-2-3-4.n.q.dht.example.com 1-2-3-4.n.q.dht.example.com. 6435 IN A 1.2.3.4

The bridge device 21 returns the generated DNS records of the selected computers as the response to the DNS inquiry to the stub resolver 25 (S25).

The stub resolver 25 that receives the response selects one computer included in the response, and continues to DNS-inquire of the converting device 41 in the selected computer about the reference name (123456.q.dht.example.com) (S26).

The converting device 41, which receives the DNS inquiry, extracts the goods number 123456 from the reference name, and the computer including this converting device 41 obtains a hash value of the goods number 123456 by using the hash function. The DHT network 22 cooperates to carry out retrieval by using this hash value to specify a computer having this hash value. The specified computer retrieves an NAPTR record related with the hash value from its own database by using the hash value as a retrieval key. The converting device 41 in the computer that carries out the retrieval or the converting device 41 in the computer that receives the DNS inquiry returns the retrieved NAPTR record to the stub resolver 25 by using a response message format according to a DNS protocol (S27).

The stub resolver 25 that receives the response returns the NAPTR record as the response to the DNS inquiry to the DNS resolver 47 (S28).

The DNS resolver 47 transmits the received NAPTR record to the NAPTR application unit 46 (S29).

The NAPTR application unit 46 accesses to the server 48 that provides the service using the NAPTR record by using the received NAPTR record.

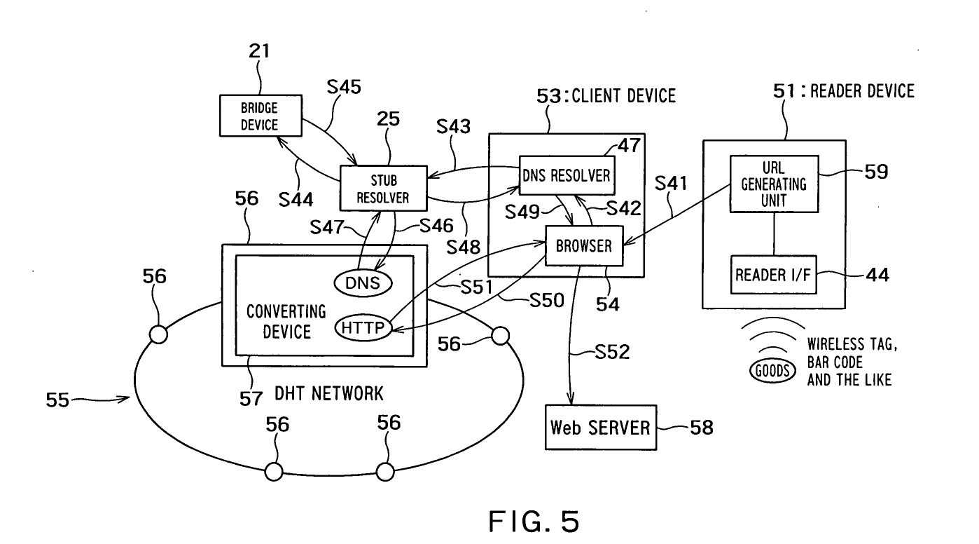

FIG. 5 is a diagram illustrating the second application example of the network retrieval system in FIG. 2.

In this example, URL related with a goods number read from goods by the reader device is acquired from the DHT network via DNS based on the goods number. Accessing to a Web server having the URL is performed. This example will be explained in detail below.

An URL generating unit 59 in the reader device 51 generates URL by using the goods number read by the reader according to a separately determined coding method. The generated URL is called as reference URL.

The reference URL is composed of a WWW server name belonging to the second domain (q.dht.example.com), a separately determined port number, an operation identifier (mentioned later), a parameter (mentioned later) and a goods number. The reader device 51 generates, for example, the following reference URL for the goods number 123456789:
http://www.q.dht.example.com: 14996/Item?itemID=123456789

The reader device 51 transmits the generated reference URL to a browser 54 in the client device 53 (S41).

The browser 54 transmits the received reference URL to the DNS resolver 47 (S42), and the DNS resolver 47 DNS-inquires of the stub resolver 25 about the domain name “www.q.dht.example.com” in the received reference URL (S43).

When the stub resolver 25 receives the DNS inquiry from the DNS resolver 47, it repeatedly executes the DNS inquiry for the reference URL (recursive inquiry). For example, the stub resolver 25 acquires an IP address or the like of the bridge device 21 to which the authority for the domain “dht.example.com” is delegated, from the DNS server 14 (see FIG. 2) that manages the domain “example.com”. The stub resolver 25 continues the recursive inquiry to the bridge device 21 as the authorized device (S44).

When the bridge device 21 receives the DNS inquiry from the stub resolver 25, it selects computers whose number (suitable number) is determined by a redundancy parameter according to a suitable method, and generates DNS records for delegating the authority for the domain “q.dht.example.com” to the selected computers.

That is to say, the bridge device 21 generates the domain names for the selected computers, respectively. The bridge device 21 calculates TTL similarly to the above manner. The bridge device 21 generates the DNS records for the selected computers, respectively, by using the generated domain names and the calculated TTL.

The bridge device 21 returns the generated DNS records of the selected computers as the response to the DNS inquiry to the stub resolver 25 (S45).

The stub resolver 25 which receives the response selects one computer to which the authority for the domain “d.dht.example.com” is delegated based on the DNS records included in the response, and continues the DNS inquiry (about “www.q.dht.example.com”) to the converting device in the selected computer (S46).

Here, an A record related with the domain name “www.q.dht.example.com” is set in the converting devices 57 in the computers of the DHT network 22. More specially, IPv4 address and IPv6 address are set in each converting device 57 with the domain name. The converting device 57 in the selected computer, which receives the DNS inquiry about the domain name “www.q.dht.example.com” from the stub resolver 25, therefore, returns its IPv4 address and IPv6 address as response to the DNS inquiry (S47).

The stub resolver 25 that receives the response returns the received IPv4 address and the IPv6 address as the response to the DNS inquiry to the DNS resolver 47 (S48).

The DNS resolver 47 transmits the acquired IPv4 address and the IPv6 address to the browser 54 (S49).

The browser 54 makes HTTP request http://www.q.dht.example.com:14996/Item?itemID=123456789 to a determined port number (14996) of the converting device 57 having the IPv4 address and the IPv6 address by using any one of the IPV4 address and the IPv6 address (S50). The IPv4 address or the IPv6 address returned at step S49 is internally inserted to a part of “www.q.dht.example.com”. As a result, the browser 54 accesses to the determined port number of the corresponding converting device by means of HTTRP.

In this application example, an HTTP program is stored in the converting devices 57 in the computers of the DHT network 22, and the converting devices 57 operate also as the HTTP server. The converting device 57 which receives the HTTP request, therefore, interprets a request character string (/Item?itemID=123456789) in the HTTP request and executes a process related with this.

More concretely, the request character string includes an identifier Item that represents a type of an operation to be request (here, an operation for acquiring URL) and a goods number (a value of a parameter itemID). The converting device 57, therefore, instructs the computer including itself to retrieve a code (URL) corresponding to the goods number (123456789).

The computer that receives the instruction calculates a hash value of the goods number, and the DHT network 55 specifies the computer that manages the hash number in the database. The specified computer retrieves URL related with this hash value from the database. The converting device 57 in the computer that carried out the retrieval or the converting device 57 that receives the retrieval instruction notifies the browser 54 in the client device 53 of the retrieved URL by using a redirecting function of HTTP (a function for instructing redirection to another URL) (S51).

The browser 54 which receives the URL acquires an IP address related with the URL by using the DNS 10, and then accesses to the Web server 58 having this IP address which stores the goods information about the goods number 123456789 therein (S52).

In this manner, the user uses the reader device that codes the goods number read from the goods into the reference URL to be capable of acquiring URL corresponding to the goods number via DNS and the DHT network without alternating software in the client device. That is to say, the user transparently uses the DHT space via the DNS space to be capable of acquiring a desired code (URL etc.) at high speed without deteriorating the characteristics of the DHT network (scale expandability and non-convergency).

In the above explanation with reference to FIG. 3, the node group management unit 32 in the bridge device 21 searches the DHT network 22 in which a participation state of the computers dynamically changes to produce the list of the computers. At the time of the authority delegating process by the DHS authority delegation mechanism 31, the suitable number of the computers is selected by the suitable method, and the information about the selected computers is passed to the DNS response generating unit 33. One example of the concrete method of selecting the computers will be explained below.

In the case where an algorithm (for example, Chord) for interconnecting the computers in the DHT network in series (the number of adjacent computers is two) is used as the distributed hash algorithm, the following method is assumed. In this method, the node group management unit 32 searches the DHT network 22 to sequentially acquire the information about computers adjacent to a known computer. At the time of the authority delegating process by the DNS authority delegation mechanism 31, the information about the computers are passed to the DNS response generating unit 33 in acquired order etc. This method will be further detailed below.

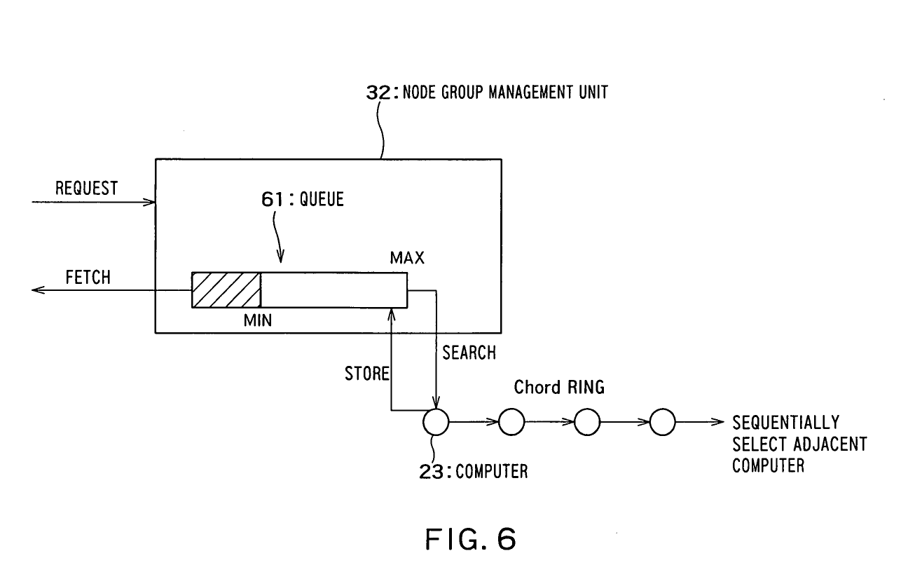

FIG. 6 is a diagram explaining an operation of the node group management unit 32 at the time of executing this method.

The node group management unit 32 has a node queue 61 storing the acquired information about the computers therein. At the time of actuating the bridge device 21, the node group management unit 32 searches the DHT network to sequentially detect computers adjacent to the known computer and store information of detected computers in the node queue 61. The node queue 61 has a minimum value (MIN), a maximum value (MAX) and a parameter. Theses values define the process of the node group management unit 32.

More concretely, the node group management unit 32 sequentially detects the computers adjacent to the known computer until the number of pieces of the information about the computers in the node queue 61 reaches the maximum value (MAX), and stores the information about the detected computers in the node queue 61. At the time of the authority delegating process by the DHT authority delegation mechanism 31, the node group management unit 32 fetches the information about the computers whose number corresponds to the parameter from the node queue 61, and passes them to the DNS response generating unit 33. When the length of the node queue 61 becomes smaller than the minimum value, the node group management unit 32 prioritizes the search of the DHT network (detection of computers). That is to say, at the time of the authority delegating process by the DHT authority delegation mechanism 31, when the length of the node queue 61 becomes smaller than the minimum value, the node group management unit 32 waits for passing the information about the computers to the DNS response generating unit 33 until the search of the DHT network is completed.

In the case where an algorithm such as Tapestry where a number of computers adjacent to a computer is three or more is used as the distributed hash algorithm, the node group management unit 32 may select the computers according to an arbitrary method.

Further, it is preferable that the computers selected by the node group management unit 32 are close in distance to the stub resolver 25. The node group management unit 32 may be, therefore, provided with a routing list of an internet protocol level to select a computer having an IP address predicted to be the closest in distance to the stub resolver 25 from the node queue 61.

A concrete example of the TTL calculation method by the TTL calculator 34 (see FIG. 3) will be explained below.

One example that the TTL calculator 34 dynamically calculates the TTL based on the loading states of the computers composing the DHT network and the loading states of the bridge device 21 will be explained below.

As explained above, TTL can be set in the NS resource record for the second domain (q.dht.example.com) (in the above example, 6435 is set as the TTL). In this example, the TTL is controlled according to the following two principles.
1. When the loading state of the computers having the converting devices is high, TTL is shortened and thus the loading state of the converting devices is not increased very much. On the contrary, when the loading state is low, TTL is lengthened and thus the role of the converting device is called on for a long time.
2. When the loading state of the bridge device 21 is high, TTL is lengthened and thus the frequency of the inquiry is decreased. On the contrary, when the loading state of the bridge device 21 is low, TTL is shortened and thus the frequency of the inquiry is increased, thereby the load for retrieval is distributed to the computers efficiently.

In order to realize the above two principles,
Ltn: the loading state of a corresponding converting device; and
Lbn: the loading state of the bridge device are used as an argument of the function for calculating the TTL.

The TTL calculator 34 calculates the TTL by using the function to pass it to the DNS response generating unit 33, and the DNS response generating unit 33 uses the received TTL as the TTL of the NS resource record.

One example of the function for calculating the TrL is described below.
Ftt1(Ltn, Lbn)=cTTL+bTTL*(1.0−Ltn)*Lbn (Formula 1)
Ltn and Lbn are normalized between 0.0 (no load) and 1.0 (overload). cTTL is a constant for defining the lowest TTL, and has a function for preventing excessive re-inquiries. For example, 300 seconds is used as cTTL. On the other hand, bTTL is a constant for defining the maximum TTL. When the loading state of a corresponding converting device is zero and the bridge device is in overload, the TTL becomes cTTL+bTTL according to the formula (1). bTTL is determined such that the TTL becomes, for example, 604800 seconds (one week).

As for Ltn, for example, the percentage of the time required for a process (the total time from reception of the inquiry to return of the retrieved result) in certain constant time, is adopted as Ltn, and self-enumeration of the computer is used. When the percentage is actually calculated, for example, the processing time is integrated per minute, and the percentage per minute is calculated to obtain a weighted average of the percentage per minute for proximate 10 minutes. In another method, Ltn may be determined based on a size of an area in a DHT-ID space occupied by the computer according to the assumption that the number of the inquiries to the computer is proportional to the size of the area in the DHT-ID space occupied by the computer.

As for Lbn, for example, the percentage of the time in constant time at which the length of the node queue has the maximum value is adopted as Lbn. As a result, when the calculated percentage is smaller than a first reference value, for example, the speed of the inquiry is very higher than the search speed of the computer, and thus the computer are overloaded. On the other hand, when the percentage is larger than a second reference value, the inquiry speed is very smaller than the search speed of the computer, and thus the computer is no loaded. Needless to say, Lbn may be calculated based on the time taken for the search process and the time taken for responding to the inquiries, and in this case, the weighted averaging method may be used similarly to the calculation of Ltn.

A combination of the method of selecting the computers and the method of calculating the TTL may be used.

In this embodiment, Chord is mainly used as the distributed hash algorithm, but another algorithm such as Tapestry and CAN can be used.

What is claimed is:

1. A network retrieval system including plural computers arranged on a network in which in case where any one of the computers is instructed to retrieve certain information, the plural computers cooperate to retrieve the certain information by using a distributed hash table according to a distributed hash algorithm, comprising:
plural converting devices arranged correspondingly to the plural computers, wherein each converting device has authority to manage a first domain as a part of a domain name space, and in case of receiving a name resolving request for a domain name including the first domain, instructs the corresponding computer to carry out retrieval based on the name resolving request and receives a result retrieved according to the distributed hash algorithm from the corresponding computer to transmit the retrieved result as a response to the name resolving request;
a bridge device that manages the converting devices and has authority to manage a second domain whose hierarchy is higher than that of the first domain, and in case of receiving a name resolving request for the domain name including the first domain, notifies a transmission source of the name resolving request of at least any location of the converting devices to which the name resolving request is entrusted; and
a client device that requests the bridge device to resolve the domain name including the first domain to acquire the location of the converting device to which a name resolving request is entrusted, and requests the converting device having the acquired location to resolve the domain name including the first domain to acquire a retrieved result from the converting device.

2. The network retrieval system according to claim 1, wherein
the bridge device calculates time-to-live of the location of the converting device and notifies the client device of the time-to-live together with the location of the converting device, and
in case where a previously acquired location is within the time-to-live, the client device requests the converting device having the location within the time-to-live to resolve the domain name including the first domain.

3. The network retrieval system according to claim 2, wherein the bridge device calculates the time-to-live according to a loading state of the computer corresponding to the converting device.

4. The network retrieval system according to claim 2, wherein the bridge device calculates the time-to-live according to a loading state of itself.

5. An information retrieval method in which in case where any one of plural computers arranged on a network is instructed to retrieve certain information, the plural computers cooperate to retrieve the certain information by using a distributed hash table according to a distributed hash algorithm, comprising:
requesting by a client device a bridge device to resolve a domain name including a first domain as a part of domain name space, the bridge device having authority to manage a second domain whose hierarchy is higher than that of the first domain;
selecting by the bridge device at least any one of converting devices arranged correspondingly to the computers, the converting devices having authority to manage the first domain, respectively;
notifying by the bridge device the client device of a location of the selected converting device to which a name resolving request is entrusted;
requesting by the client device the converting device having the notified location to resolve the domain name including the first domain;
instructing by the converting device the corresponding computer to carry out retrieval based on a name resolving request from the client device, to receive a result retrieved according to the distributed hash algorithm from the corresponding computer; and
transmitting by the converting device the retrieved result as a response to the name resolving request to the client device.

6. The information retrieval method according to claim 5 further comprising;
calculating by the bridge device time-to-live of the location of the converting device and notifies the client device of the time-to-live together with the location of the converting device, and
in case where a previously acquired location is within the time-to-live, requesting by the client device the converting device having the location within the time-to-live to resolve the domain name including the first domain.

7. The information retrieval method according to claim 6, comprising calculating the time-to-live according to a loading state of the computer corresponding to the converting device.

8. The information retrieval method according to claim 6, comprising calculating the time-to-live according to a loading state of itself.

9. A bridge device that has authority to manage certain domain in a domain name space, comprising:
a management unit that manages plural computers arranged on a network, wherein in case where one of the computers is instructed to retrieve certain information, the plural computers cooperate to retrieve the certain information by using a distributed hash table according to a distributed hash algorithm;
a selecting unit that selects at least any one of the plural computers in case of receiving a name resolving request for a domain name including the certain domain; and
a responding unit that transmits a location of the selected computer as a response to the name resolving request.

10. The bridge device according to claim 9, wherein the responding unit transmits the location of the selected computer as a destination of a computer to which the name resolving request is entrusted.

11. The bridge device according to claim 9, wherein
the bridge device further comprises a time-to-live calculation unit calculating time-to-live of the location of the computer, and
the responding unit transmits the time-to-live together with the location of the computer.

12. The bridge device according to claim 11, wherein
the management unit calculates a loading state of the computer, and
the time-to-live calculation unit calculates the time-to-live according to the calculated loading state.

13. The bridge device according to claim 11, wherein
the management unit calculates a loading state of itself, and
the time-to-live calculation unit calculates the time-to-live according to the calculated loading state.

14. A program for inducing a device that has authority to manage certain domain in a domain name space, to execute:
receiving a name resolving request for a domain name including the certain domain;
selecting at least any one of plural computers arranged on a network, wherein in case where any one of the computers is instructed to retrieve certain information, the plural computers cooperate to retrieve the certain information by using a distributed hash table according to a distributed hash algorithm; and
transmitting a location of the selected computer as a response to the name resolving request.

15. The program according to claim 14, wherein the transmitting includes transmitting the location of the selected computer as a destination of a computer to which the name resolving request is entrusted.

16. The program according to claim 14, for inducing the device to execute further:
calculating time-to-live of the location of the computer, and
transmitting the time-to-live together with the location of the computer.

17. The program according to claim 16, for inducing the device to execute further calculating a loading state of the computer, wherein
the calculating the time-to-live includes calculating the time-to-live according to the calculated loading state.

18. The program according to claim 16, for inducing the device to execute further calculating a loading state of the device, wherein
the calculating the time-to-live includes calculating the time-to-live according to the calculated loading state.
